(19) United States
(12) Patent Application Publication
(10) Pub. No.: US 2018/0160837 A1
(43) Pub. Date: Jun. 14, 2018

(54) Curtain Bracket for a Sliding Door

(71) Applicant: Anthony Jerome Middleton, Round Rock, TX (US)

(72) Inventor: Anthony Jerome Middleton, Round Rock, TX (US)

(21) Appl. No.: 15/841,286

(22) Filed: Dec. 13, 2017

Related U.S. Application Data
(60) Provisional application No. 62/433,659, filed on Dec. 13, 2016.

(51) Int. Cl. A47H 1/142; F16B 2/22

(52) U.S. Cl. CPC A47H 1/142; F16B 2/22

(57) ABSTRACT

A curtain bracket for a sliding-door allows a curtain to be retrofitted onto a rail used for vertical blinds. The curtain bracket utilizes a bracket, a positioning arm, and a first hanger. The bracket is used to for a snap fitting between the curtain bracket and the rail. The rail is positioned over the sliding door to allow the curtains to completely conceal the sliding door. The positioning arm positions a curtain rod parallel and offset from the rail, allowing a curtain to be freely open and close. This also enables the curtain to be used in conjunction with vertical blinds. The first hanger is designed to receive a cylindrically-shaped curtain rod. A rail-receiving opening of the bracket accept the top portion of the rail. A rod-receiving opening of the first hanger allows the curtain rod to be inserted into or extracted out of the first hanger.

The current application claims a priority to the U.S. Provisional Patent application Ser. No. 62/433,659 filed on Dec. 13, 2016.

### FIELD OF THE INVENTION

The present invention generally relates to a curtain bracket for a sliding door. More specifically, the present invention is a curtain bracket that releasably mounts onto a rail used for vertical blinds.

### BACKGROUND OF THE INVENTION

Many people have sliding doors and have oftentimes wanted to put curtains on without having to put holes on the walls to mount the brackets. Conventional sliding doors utilize vertical blinds as the preferred concealing means. Vertical blinds slide along a rail mounted above the sliding door. However, the vertical blinds can get stuck on the rails. Additionally, since vertical blinds are made of rigid plastics, they can get worn out and break apart. Further vertical blinds usually are only available in single solid colors and are unsuited to display an ornamental design. As a result, many users may not find vertical blinds as aesthetically pleasing as curtains. Thus, users may want to substitute vertical blinds with fabric curtains.

In order to attach curtains to the sliding doors, users must first drill holes into the wall to receive curtain brackets. If the rail is not removed the curtain brackets must be elongated to clear the added width of the rail. This makes it exceptionally difficult to retrofit curtains onto an existing sliding door.

The objective of the present invention to provide a curtain bracket for retrofitting curtains onto a sliding door without having to drill holes or remove the rail. The present invention is capable of releasably mounting onto a rail used for vertical blinds. Further, the present invention uses snap fitting components that obviate the need to drill holes or permanently alter the wall. The present invention can also be configured to hang curtains over existing vertical blinds, thereby giving the user the option to use vertical blinds or the curtains, selectively.

### BRIEF DESCRIPTION OF THE DRAWINGS

FIG. 1 is a top perspective view of the present invention.

FIG. 2 is a bottom perspective view of the present invention.

FIG. 3 is an exploded view of the present invention showing the first hanger, the bracket, and the releasable fastener.

FIG. 4 is a side view of the bracket.

FIG. 5 is a side view of the first hanger and the extension arm.

FIG. 6 is a top perspective view of an embodiment of the present invention comprising the first hanger, the second hanger, and the extension arm.

FIG. 7 is a side view of the embodiment of the present invention comprising the first hanger, the second hanger, and the extension arm.

### DETAILED DESCRIPTION OF THE INVENTION

All illustrations of the drawings are for the purpose of describing selected versions of the present invention and are not intended to limit the scope of the present invention.

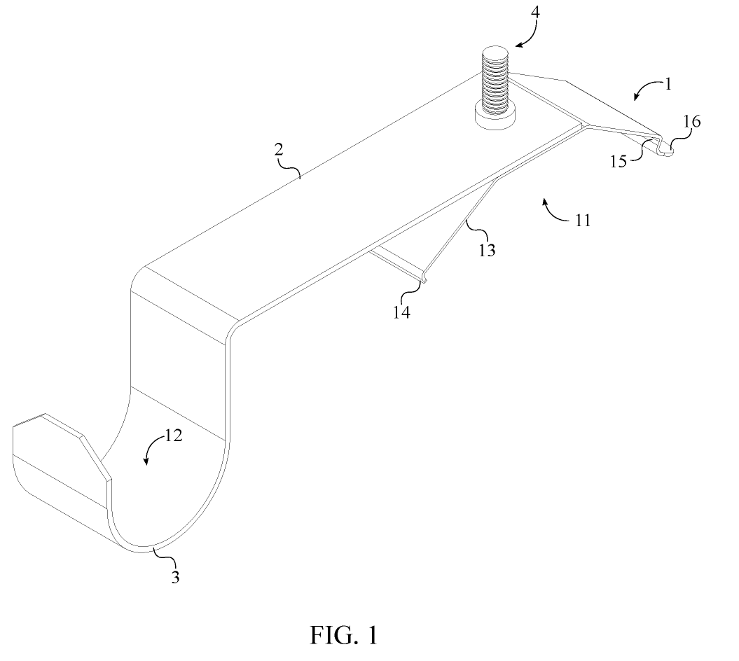

The present invention is a curtain bracket for a sliding-door capable of releasably coupling a first curtain rod onto a sliding-door. More specifically, the present invention allows curtains or drapery to be retrofitted onto an existing sliding-door. Referring now to FIG. 1, the preferred embodiment of the present invention comprises a bracket 1, a positioning arm 2, and a first hanger 3. Conventional sliding doors usually comprise a rail that holds vertical blinds. The rail is usually located on the upper edge of the sliding door, which makes it an ideal place for hanging a curtain. Thus, the bracket 1 snaps onto the rail of the sliding door, thereby fastening the positioning arm 2 and the first hanger 3 onto the rail. The positioning arm 2 positions the first hanger 3 offset from the bracket 1 to receive the first curtain rod. More specifically, the first hanger 3 is terminally attached to the positioning arm 2. Preferably, both the first hanger 3 and the positioning arm 2 are made by bending a single sheet of steel. The first hanger 3 is made by bending the terminal portion of the sheet into a U-shape. Similarly, the positioning arm 2 is the straight portion of the sheet. Alternately, the first hanger 3 and the positioning arm 2 may be separate components that are fused together. The first hanger 3 being terminally connected to the positioning arm 2, opposite the bracket 1. This offsets the first curtain rod from the rail.

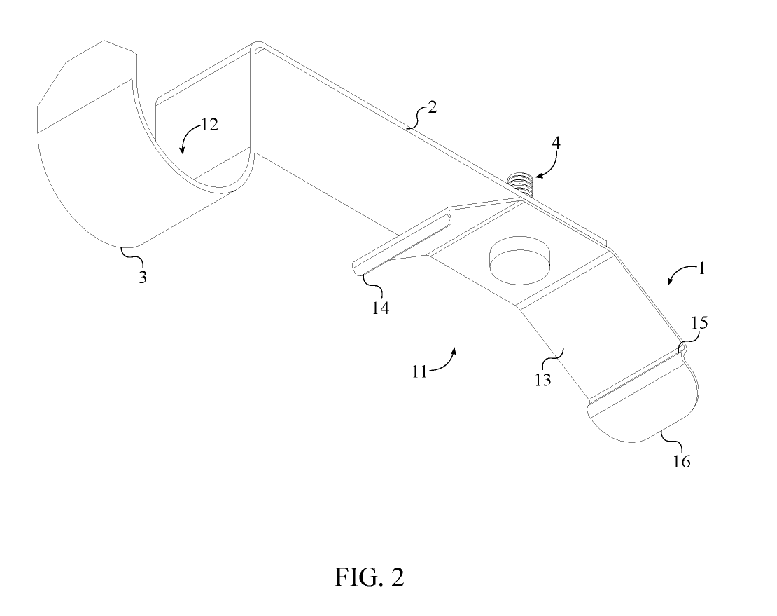

FIG. 2 shows a rail-receiving opening 11 of the bracket 1 oriented perpendicular to the positioning arm 2. The rail-receiving opening 11 is sized smaller than the rail to create a snap fit between the bracket 1 and the rail. A rod-receiving opening 12 of the first hanger 3 is oriented perpendicular to the positioning arm 2. The rod-receiving opening 12 is preferably delineated by the U-shaped sheet of steel. The arcuate shape of the rod-receiving opening 12 ensures a secure fit with the cylindrically-shaped first curtain rod. In the preferred embodiment, the flexible bow 13 is mounted on top of the rail. Consequently, the rail-receiving opening 11 is positioned facing downwards. The rod-receiving opening 12 must be positioned facing upwards to properly support the curtain rod. Therefore, the rail-receiving opening 11 of the bracket 1 and the rod-receiving opening 12 of the first hanger 3 are oriented opposite to each other. Preferably, the first hanger 3 laterally attaches to the curtain rod. The vertical blinds may either be detached from the rail or may still be attached. In case the vertical blinds are still attached, it is desirable to offset the first hanger 3 from the rail, to allow the curtain to freely open and close. Thus, the curtain rod is positioned parallel and offset from the rail, allowing a curtain to be hung in front of the vertical blinds.

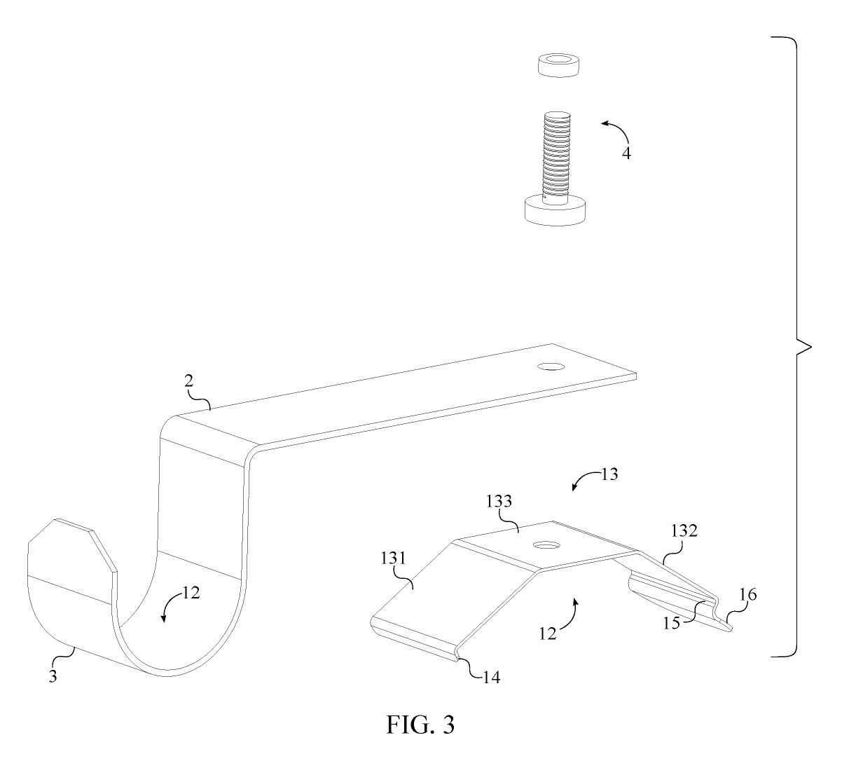

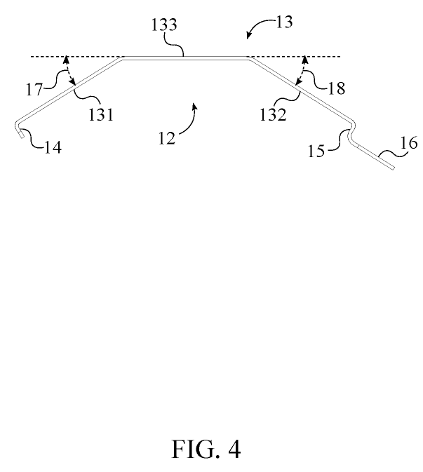

Referring now to FIG. 3 and FIG. 4, the preferred embodiment of the present invention retrofits a first curtain rod onto the rail of existing sliding-doors. More specifically, the bracket 1 is used to releasably fasten the positioning arm 2 and the first hanger 3 onto the rail. As such, the bracket 1 comprises a flexible bow 13, a first claw 14, and a second claw 15. The flexible bow 13 elastically bends about a bending axis. To insert the rail, the user bends the flexible bow 13 outwards and inserts the rail into the rail-receiving opening 11. Once inside the rail-receiving bow, the flexible bow 13 snaps back onto the lateral sides of the rail. The first claw 14 and the second claw 15 further secures the rail inside the rail-receiving opening 11. The first claw 14 is terminally connected to the flexible bow 13. Likewise, the second claw 15 is terminally connected to the flexible bow 13, opposite the first claw 14. Further, the first claw 14 and the second claw 15 are oriented towards each other. As a result, an edge of the first claw 14 presses against a lateral side of the rail, and an edge of the second claw 15 presses against an opposite lateral side of the rail. The force of the first claw 14 and the second claw 15 pressing against the rail creates a friction bond between rail and the bracket 1.

The bracket 1 may further comprises a release tab 16 for disengaging the flexible bow 13. Preferably, the release tab 16 is connected adjacent to the second claw 15, though in alternate embodiments, the release tab 16 may be positioned anywhere on extremities of the bracket 1. This allows a user to leverage the distance between the release tab 16 and the bend axis of the flexible bow 13 to easily pull the first claw 14 and the second claw 15 apart. Further, the release tab 16 is oriented away from the first claw 14. This allows the user to securely grip and pull the release tab 16. Pulling the release tab 16 causes the flexible bow 13 to bend outwards, enabling the rail to be pulled out of the bracket 1. In the preferred embodiment, the rail-receiving opening 11 of the bracket 1 is defined in between the first claw 14 and the second claw 15. Once the rail is inserted into the rail receiving bracket 1, the first claw 14 and the second claw 15 press against opposite lateral sides of the rail, thereby securing the rail inside the bracket 1.

Referring more specifically to FIG. 4, focusing now on the flexible bow 13, the flexible bow 13 comprises a first flat portion 131, a second flat portion 132, and a middle flat portion 133. The rail-receiving opening 11 is further delineated by the first flat portion 131, the second flat portion 132, and the middle flat portion 133. The first flat portion 131 is positioned adjacent to the middle flat portion 133. Likewise, the second flat portion 132 is positioned adjacent to the middle flat portion 133, opposite to the first flat portion 131. The first flat portion 131 and the second flat portion 132 form the sides of the flexible bow 13 that laterally supports the rail. Preferably, the first flat portion 131 is oriented at a first obtuse angle 17 to the middle flat portion 133. Similarly, the second flat portion 132 is oriented at a second obtuse angle 18 with the middle portion. Preferably, the first obtuse angle 17 is measured along the clockwise direction from the middle flat portion 133, whereas second obtuse angle 18 is measured along the counter-clockwise direction from the middle flat portion 133. Together, the first flat portion 131 and the second flat portion 132 taper the rail-receiving opening 11 inwards towards the middle flat portion 133. This ensures that the first flat portion 131 and the second flat portion 132 remain in contact with the lateral sides of the rail.

Referring more specifically to FIG. 3, in the preferred embodiment, the bracket 1 is releasably mounted onto the positioning arm 2 via a releasable fastener 4. More specifically, the bracket 1 is terminally attached to the positioning arm 2 by the releasable fastener 4. The preferred releasable fastener 4 comprises a nut and a bolt. The bolt is fashioned with male threads capable of interlocking with the female threads on the nut. The bolt traverses through a bolt-accepting hole of the positioning arm 2 and a bolt-accepting hole of the middle flat portion 133. A bolt head of the bolt braces the middle flat portion 133. The nut screws onto the bolt and braces the positioning arm 2, opposite the bolt head. Thus, the nut and the bolt fasten the positioning arm 2 and the bracket 1 together.

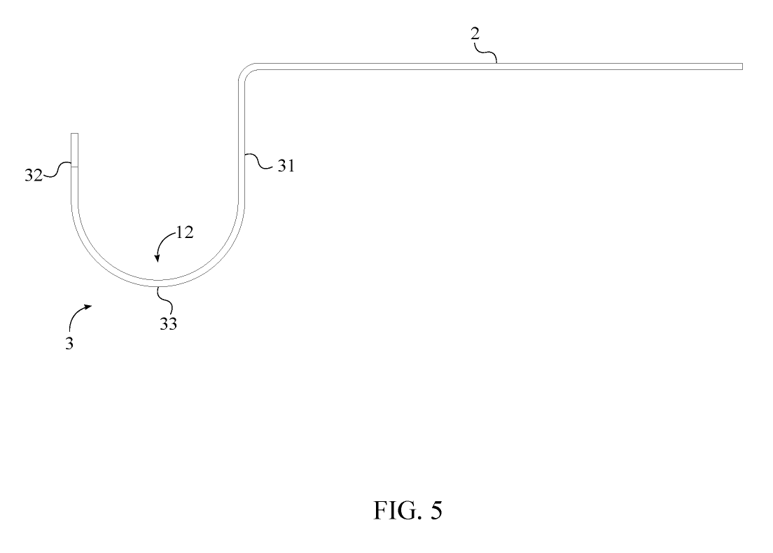

FIG. 5 shows a detail view of the first hanger 3. The preferred embodiment of the first hanger 3 comprises a first leg 31, a second leg 32, and a curved web 33. Preferably, the first leg 31, the second leg 32, and the curved web 33 are configured into a U-shaped structure that delineates the rod-receiving opening 12. The first leg 31 connects the first hanger 3 to the positioning arm 2. Thus, the first leg 31 is positioned perpendicular to the positioning arm 2. The first leg 31 is terminally connected to the curved web 33. Similarly, the second leg 32 is terminally connected to the curved web 33, opposite the first leg 31. This positions the second leg 32 parallel to the first leg 31. This also positions the first leg 31 offset to the second leg 32, allowing the rod-receiving opening 12 of the first hanger 3 to be defined in between the first leg 31 and the second leg 32. To attach the first curtain rod to the present invention, the first curtain rod is simply dropped into the rod-receiving opening 12. Once inside the first hanger 3, the bottom part of the cylindrically-shaped first curtain rod is vertically supported by the curved web 33. Similarly, the first curtain rod is laterally supported by the first leg 31 and the second leg 32. To detach the first curtain rod from the present invention, the first curtain rod is simply lifted out of the rod-receiving opening 12.

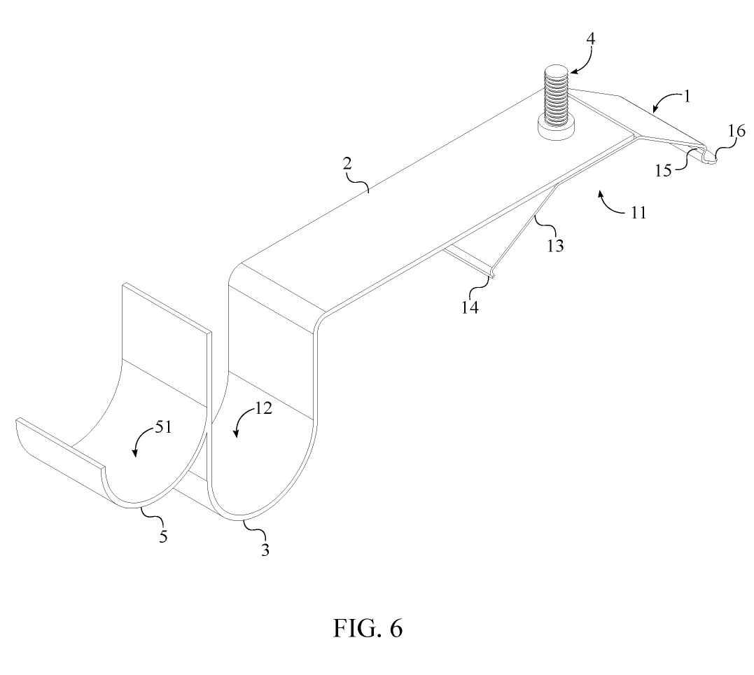

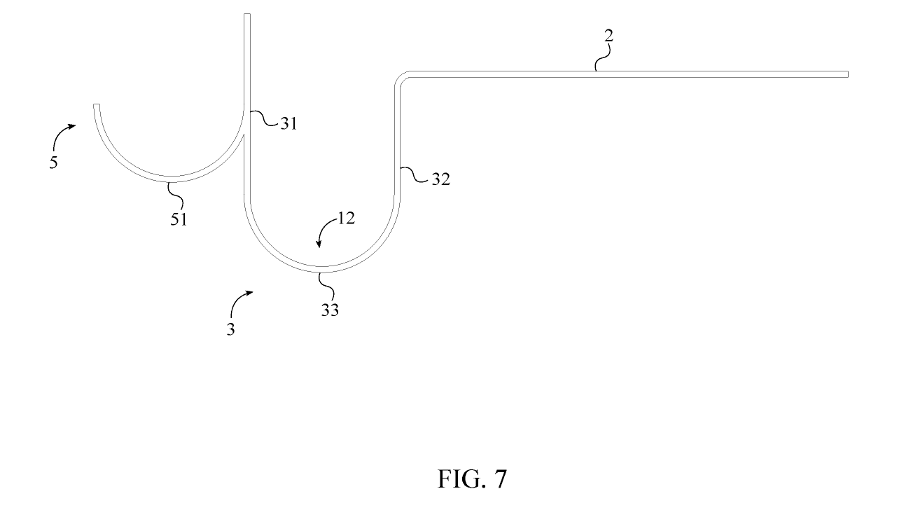

FIG. 6 and FIG. 7 shows an alternate embodiment of the present invention. A second hanger 5 allows the present invention to support two curtain rods. Preferably, the second hanger 5 is connected adjacent to the first hanger 3, opposite the positioning arm 2. Together, the first hanger 3 and the second hanger 5 allow two curtain rods to be positioned parallel and vertically offset from each other. A rod-receiving opening 12 of the second hanger 5 is oriented perpendicular to the positioning arm 2. The rod-receiving opening 12 of the second hanger 5 is also oriented opposite the rail-receiving opening 11 of the bracket 1. In the preferred embodiment, a second curtain rod is inserted into the rod-receiving opening 12 of the second hanger 5. As a result, the second curtain rod is positioned offset and parallel to the rail of the sliding-door.

Referring more specifically to FIG. 7, in the preferred implementation of the present invention, the first hanger 3 and the second hanger 5 each comprises a curved web 51. The curved web 51 of the first hanger 3 is positioned offset from the curved web 51 of the second hanger 5. The first curtain rod and the second curtain rod are used to support curtains that overlap each other. Overlapping the curtains can be used to create more visually pleasing look. Alternately, the first curtain rod and the second curtain rod may also support curtain loops for curtains and drapes.

Although the invention has been explained in relation to its preferred embodiment, it is to be understood that many other possible modifications and variations can be made without departing from the spirit and scope of the invention as hereinafter claimed.

What is claimed is:

1. A curtain bracket for a sliding-door comprises:
a bracket;
a positioning arm;
a first hanger;
the bracket being terminally attached to the positioning arm;
the first hanger being terminally connected to the positioning arm, opposite the bracket;
a rail-receiving opening of the bracket being oriented perpendicular to the positioning arm;
a rod-receiving opening of the first hanger being oriented perpendicular to the positioning arm; and
the rail-receiving opening of the bracket and the rod-receiving opening of the first hanger being oriented opposite to each other.

2. The curtain bracket for a sliding-door as claimed in claim 1 comprises:
the bracket comprises a flexible bow, a first claw, and a second claw;
the first claw being terminally connected to the flexible bow;
the second claw being terminally connected to the flexible bow, opposite to the first claw; and
the first claw and the second claw being oriented towards each other.

3. The curtain bracket for a sliding-door as claimed in claim 2 comprises:
the bracket further comprises a release tab;
the release tab being connected adjacent to the second claw; and
the release tab being oriented away from the first claw.

4. The curtain bracket for a sliding-door as claimed in claim 2 comprises:
the rail-receiving opening of the bracket being defined in between the first claw and the second claw.

5. The curtain bracket for a sliding-door as claimed in claim 2 comprises:
the flexible bow comprises a first flat portion, a second flat portion, and a middle flat portion;
the first flat portion being positioned adjacent to the middle flat portion;
the second flat portion being positioned adjacent to the middle flat portion, opposite the first flat portion;
the first flat portion being oriented at a first obtuse angle with the middle portion; and
the second flat portion being oriented at a second obtuse angle with the middle portion.

6. The curtain bracket for a sliding-door as claimed in claim 1 comprises:
a releasable fastener; and
the bracket being terminally attached to the positioning arm by the releasable fastener.

7. The curtain bracket for a sliding-door as claimed in claim 1 comprises:
the first hanger comprises a first leg, a second leg, and a curved web;
the first leg being positioned perpendicular to the positioning arm;
the first leg being terminally connected to the curved web;
the second leg being terminally connected to the curved web, opposite the first leg; and
the second leg being positioned parallel to the first leg.

8. The curtain bracket for a sliding-door as claimed in claim 7 comprises:
the rod-receiving opening of the first hanger being defined in between the first leg and the second leg.

9. The curtain bracket for a sliding-door as claimed in claim 1 comprises:
a second hanger;
the second hanger being connected adjacent to the first hanger, opposite the positioning arm;
a rod-receiving opening of the second hanger being oriented perpendicular to the positioning arm; and
the rod-receiving opening of the second hanger being oriented opposite to the rail-receiving opening of the bracket.

10. The curtain bracket for a sliding-door as claimed in claim 9 comprises:
the first hanger and the second hanger each comprises a curved web; and
the curved web of the first hanger being positioned offset from the curved web of the second hanger.

11. A curtain bracket for a sliding-door comprises:
a bracket;
a positioning arm;
a first hanger;
a releasable fastener;
the bracket being terminally attached to the positioning arm;
the first hanger being terminally connected to the positioning arm, opposite the bracket;
a rail-receiving opening of the bracket being oriented perpendicular to the positioning arm;
a rod-receiving opening of the first hanger being oriented perpendicular to the positioning arm;
the rail-receiving opening of the bracket and the rod-receiving opening of the first hanger being oriented opposite to each other; and
the bracket being terminally attached to the positioning arm by the releasable fastener.

12. The curtain bracket for a sliding-door as claimed in claim 11 comprises:
the bracket comprises a flexible bow, a first claw, a second claw, and a release tab;
the first claw being terminally connected to the flexible bow;
the second claw being terminally connected to the flexible bow, opposite to the first claw;
the first claw and the second claw being oriented towards each other;
the release tab being connected adjacent to the second claw; and
the release tab being oriented away from the first claw.

13. The curtain bracket for a sliding-door as claimed in claim 12 comprises:
the rail-receiving opening of the bracket being defined in between the first claw and the second claw.

14. The curtain bracket for a sliding-door as claimed in claim 12 comprises:
the flexible bow comprises a first flat portion, a second flat portion, and a middle flat portion;
the first flat portion being positioned adjacent to the middle flat portion;
the second flat portion being positioned adjacent to the middle flat portion, opposite the first flat portion;
the first flat portion being oriented at a first obtuse angle with the middle portion; and
the second flat portion being oriented at a second obtuse angle with the middle portion.

15. The curtain bracket for a sliding-door as claimed in claim 11 comprises:
the first hanger comprises a first leg, a second leg, and a curved web;
the first leg being positioned perpendicular to the positioning arm;
the first leg being terminally connected to the curved web;
the second leg being terminally connected to the curved web, opposite the first leg;
the second leg being positioned parallel to the first leg; and
the rod-receiving opening of the first hanger being defined in between the first leg and the second leg.

16. The curtain bracket for a sliding-door as claimed in claim 11 comprises:
a second hanger;
the second hanger being connected adjacent to the first hanger, opposite the positioning arm;
a rod-receiving opening of the second hanger being oriented perpendicular to the positioning arm; and
the rod-receiving opening of the second hanger being oriented opposite to the rail-receiving opening of the bracket.

17. The curtain bracket for a sliding-door as claimed in claim 16 comprises:
the first hanger and the second hanger each comprises a curved web; and
the curved web of the first hanger being positioned offset from the curved web of the second hanger.
